(19) United States
(12) Patent Application Publication
(10) Pub. No.: US 2007/0025370 A1
(43) Pub. Date: Feb. 1, 2007

(54) Cable gateway for interfacing packet cable networks with IP multimedia subsystems

(76) Inventors: Mehdi Rais Ghasem, Monument, CO (US); Charles Arthur Witschorik, Naperville, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/192,677

(22) Filed: Jul. 30, 2005

(51) Int. Cl. H04L 12/56; H04J 3/16

(52) U.S. Cl. 370/401; 370/466

(57) ABSTRACT

The present invention provides a Cable Gateway for interfacing packet cable networks with Internet Protocol (IP) Multimedia Subsystems (IMS). The Cable Gateway includes an Embedded Multimedia Terminal Adaptor (E-MTA) Normalization function that includes translation software that normalizes E-MTA interfaces to appear to IMS as SIP user equipment and performs initialization, call signaling, registration, authentication and security. The Cable Gateway also includes a CMSS/Mw Normalization function that interworks calls going between the IMS and a Remote CMS and a Gate Controller function that implements signaling interfaces to a CMTS and allows the E-MTA Normalization function and the CMSS/Mw Normalization function to interact with the CMTS and normalizes call-flow protocols. The Cable Gateway also includes a PacketCable Multimedia (PCMM) Policy Decision Point (PDP) function that implements a PacketCable Multimedia interface and a PCMM Application Manager and a Go Proxy that monitors SIP messages to and from user equipment. The Cable Gateway also includes an Event Manager that implements an interface to a PacketCable Record Keeping Server and supports the production of call-related events on the Cable Gateway.

### FIELD OF THE INVENTION

The present invention relates generally to communication systems, and more particularly to IP Multimedia Subsystems.

### BACKGROUND OF THE INVENTION

The world cable-network community of operators, cable laboratories, and equipment suppliers has developed a successful, competitive offer for the triple-play service bundle combining: broadcast video, broadband data access, and primary-line voice. The definition and implementation of these services, while developed with a good understanding of other telecommunications technologies and networks, was tailored to the capabilities and limitations of signal delivery over a broadcast-optimized coaxial cable access network and has required a specialized product portfolio from equipment suppliers that chose to compete in the cable market.

Cable operators are no longer alone is offering these three services to the consumer. Classical PSTN operators are now extending fiber deep into their networks to support high-bandwidth service over short-loop DSL technologies, such as fiber to the neighborhood, and direct fiber to the premise, such as FTTP. With the availability of high-bandwidth to consumers, PSTN operators may offer television broadcast, data, and voice in one IP package. And with their experience with mobile networks, the next step is to create a quadruple-play that adds wireless services to the triple bundle. The cable community has reached a decision point where they need to define and implement a Next Generation Network (NGN) that adds wireless and mobility services to their triple-play bundle to help them stay competitive.

There are two primary paths for the cable operators to follow in the definition of the NGN. The first path is to repeat what they have done in the past and charter CableLabs to define the extension of PacketCable standards to accommodate wireless access, subscriber mobility, and other aspects of NGN such as session frameworks that foster independent, third-party applications. Along this path, equipment providers will be required to support specialized product lines for the cable community, certify the products with CableLabs, and manage the products in a separate product world, parallel to the product world in place for operators pursing other broadband access technologies such as DSL and FTTP.

The second path is for the cable operators to realize that coaxial cable is a broadband access technology, and only one of many. Coaxial cable is not a network technology and should not be used as the organizing principle for their NGN. In the future, broadband service operators will likely own multiple types of access networks, such as cable, PON, DSL, BFWA, etc., and for flexibility and economics will need an NGN that works with all of them, and not just from the perspective of expanding the cable footprint to absorb new access technologies. Broadband service providers will need to buy existing, non-cable broadband networks and reuse the network infrastructure that comes with them. The foundation of the NGN is the fundamental need for independence of services from access technology in the NGN. But even more critical, the definition of standards and products for an NGN above the access networks should be done cooperatively, across access technologies, not separately, in parallel definitions.

Therefore, a need exists for a next generation architecture that is designed to be independent from access technologies.

### BRIEF SUMMARY OF THE INVENTION

The present invention provides a set of functional elements that serve to normalize standard PacketCable access networks and subscriber devices into the interfaces and elements of the 3GPP/3GPP2 IMS architecture. The present invention provides a Cable Gateway, which is a standalone computing server that gives the appearance of a PacketCable CMS to elements of a PacketCable 1.5 network and the appearance of IMS functional elements to an IMS network. Both PacketCable 1.5 user equipment (UE) and SIP UE receive session control and multimedia services from core elements and application servers in the IMS network. All subscriber information is preferably provisioned in the IMS HSS and only subscriber data needed for translation between PacketCable and IMS methods and interfaces will be sent to or provisioned on the Cable Gateway. Quality of service for endpoints on the cable access network is provided through the standard use of quality gates on CMTS.

For PacketCable 1.5 UE, the Cable Gateway functions as a PacketCable 1.5 Gate Controller. The NCS protocol, and its translation to/from the SIP protocol on the IMS Gm interface, triggers the setting and removal of quality gates on the CMTS. For IMS UE on the cable access network, the Cable Gateway functions as a standard PCMM Application Manager interacting with a standard PCMM Policy Server. The IMS Policy Decision Function (PDF) indirectly triggers the setting and removal of quality gates on the CMTS through an IMS Go or Gq interface to the Cable Gateway.

### BRIEF DESCRIPTION OF THE SEVERAL VIEWS OF THE DRAWINGS

FIG. 1 depicts a communication system that includes a cable gateway and an IMS architecture to provide consumer features in a VoIP application in accordance with an exemplary embodiment of the present invention.

### DETAILED DESCRIPTION OF THE INVENTION

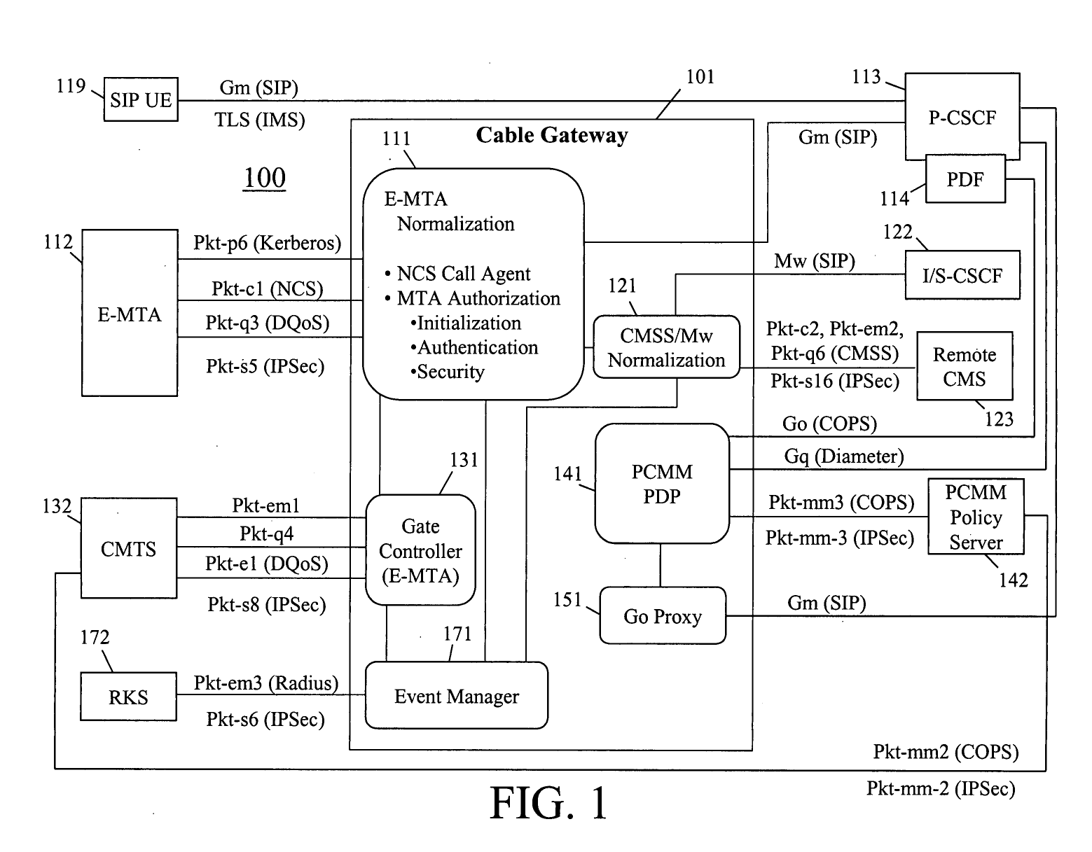

FIG. 1 depicts a communication system 100 that includes a cable gateway 101 to provide consumer features in a VoIP application in accordance with an exemplary embodiment of the present invention. Communication system 100 includes Cable Gateway 101, E-MTA (Embedded Multimedia Terminal Adaptor) 112, P-CSCF (Proxy-Call Session Control Function) 113, PDF (Policy Decision Function) 114, SIP UE 119, I/S-CSCF 122, Remote CMS 123, CMTS (Cable Modem Termination System) 132, PCMM (PacketCable Multimedia) Policy Server 142, and RKS (Record Keeping Server) 172. Cable Gateway 101 includes E-MTA Normalization 111, CMSS/Mw Normalization 121, Gate Controller (E-MTA) 131, PCMM (PacketCable Multimedia) PDP (Policy Decision Point) 141, Go Proxy 151, and Event Manager 171. In accordance with an exemplary embodiment of the present invention, the interfaces to and interaction with the IMS elements of communication system 100, P-CSCF 113, PDF 114, I/S-CSCF 122, and SIP UE 119, are defined by the Lucent Feature Server 5000, with its embedded CSCF and HSS functions.

Cable Gateway 101 is logically divided into two elements, a CMS Proxy and a PCMM Application Manager. The CMS Proxy preferably interacts with PacketCable 1.5 E-MTAs as if it was a PacketCable 1.5 CMS and normalizes the behavior of the E-MTAs to make them appear to the IMS network as multiple instances of IMS User Equipment. The CMS Proxy comprises four logical functions: E-MTA Normalization 111, CMSS/Mw Normalization 121, Gate Controller 131, and Event Manager 171. E-MTA Normalization function 111 interacts directly with PacketCable E-MTA interfaces and normalizes the behavior to the IMS Gm (SIP) interface. CMSS/Mw Normalization function 121 interworks the IMS I/S-CSCF, via the Mw (SIP) interface, to a remote PacketCable 1.5 CMS, via several PacketCable interfaces that use the CMSS protocol. Gate Controller function 131 communicates with a PacketCable 1.5 CMTS to manage QoS gates. Event Manager function 171 communicates with a PacketCable 1.5 Record Keeping Server (RKS) with call events.

PCMM Application Manager (AM) comprises PCMM PDP 141 and Go Proxy 151. The PCMM AM interacts with a PCMM Policy Server 142 to accomplish the definition, operation, and destruction of QoS gates on a PCMM CMTS as a part of the normalization of call-flow protocols. The use of the PCMM AM is specified for UE on the cable network that are not following the E-MTA protocols of PacketCable 1.5, but rather are working directly into IMS as IMS UE over the Gm (SIP) interface. Two IMS interfaces are preferably supported for the communication of QoS requests from IMS, the Gq (Diameter) interface from P-CSCF 113 and the Go (COPS) interface from PDF 114, which may be integrated within P-CSCF 113.

Cable Gateway 101 is a collection of functions that provide for the normalization of endpoints on a PacketCable 1.5 or PacketCable Multimedia access network into the appearance of SIP user equipment following the IMS Gm (SIP) interface. Cable Gateway 101 is the primary software product required for integrating PacketCable/DOCSIS access networks into 3GPP/3GPP2 IMS. The main purpose of Cable Gateway 101 is to normalize PacketCable UE into the appearance of IMS UE to IMS elements of communication system 100.

E-MTA Normalization 111 comprises translation software that normalizes E-MTA interfaces to appear to IMS as SIP user equipment that follows the IMS Gm interface. The normalization preferably covers call signaling, initialization, authentication and security as implemented over the following PacketCable interfaces: Pkt-p6 (Kerberos), Pkt-c1 (NCS), Pkt-q3 (DQoS), and IPSec.

E-MTA Normalization Software 111 is a logical definition within CMS Proxy that provides a collection area for discussion of the normalization of E-MTA behavior to that expected by IMS for SIP UE 119. Two logical software units are preferably defined for the normalization, NCS Call Agent and MTA Authorization. In accordance with a further exemplary embodiment, the normalization function can be partition in various configurations.

The NCS Call Agent is responsible for mapping the NCS protocol of the E-MTA into the IMS Gm (SIP) protocol. CableLabs specifications can be consulted for the NCS details. The NCS Call Agent should interact with the E-MTA as if it, the NCS Call Agent, is a PacketCable 1.5 CMS. For interaction with IMS, every E-MTA should have an associated proxy UE that maintains the appearance of a real IMS UE to the Lucent Feature Server 5000. The proxy UE is preferably implemented as an Advanced Endpoint, an endpoint that can locally implement call processing features such as call waiting and call transfer, and is preferably provisioned from a standard IMS provisioning server through a Provisioning Harmonization function.

MTA Authorization comprises initialization, authentication, and security. MTA Authorization preferably uses methods of PacketCable 1.5 that are mapped to registration methods used at the Gm (SIP) interface. The timeout of the security association of the E-MTA and the proxy SIP UE are preferably coordinated so that re-authentication requests from E-MTA 111 occur before the timeout of the registration in IMS.

MTA Authorization authentication preferably follows the methods of PacketCable 1.5. Authentication of the proxy UE that is maintained in Cable Gateway 101 to the IMS preferably follow the methods of IMS. In an exemplary embodiment, the Lucent FS 5000 performs access authentication using HTTP Digest framework and MD5 algorithm as specified in IETF RFC 2617 and IETF RFC 1321. The authentication is performed for every REGISTER request. Cable Gateway 101 is preferably a trusted device that holds the user identity and password that are used for HTTP Digest authentication of the proxy UE that represents an E-MTA subscription. It should be understood that more than one subscription (analog phone line) can be supported by a single E-MTA.

CMSS/Mw Normalization 121 comprises software that interworks calls going between IMS and Remote CMS 123. CMSS/Mw Normalization Software 121 provides a SIP interface with extensions that are provided to carry parameters specific to the PacketCable architecture. Since in an exemplary embodiment call processing and session control is performed outside of Cable Gateway 101, normalization software is utilized to support the interaction of IMS session control and feature server with standard PacketCable 1.5 CMSs. The IMS Mw interface from I/S-CSCF 122 is preferably normalized with the CMSS interface from CMSS/Mw Normalization 121.

Gate Controller (E-MTA) 131 comprises software that preferably implements the standard PacketCable 1.5 signaling interfaces to CMTS 132. Supported interfaces preferably include Pkt-em1, Pkt-q4, and Pkt-e1 (DQoS). In an exemplary embodiment of the present invention, PacketCable security applies to the interfaces. Gate Controller 131 includes the software needed to allow E-MTA Normalization 111 and CMSS/Mw Normalization 121 to interact with CMTS 132 to define, operate, and destroy QoS gates as a part of the normalization of call-flow protocols.

PCMM PDP 141 comprises software that implements the PacketCable Multimedia Pkt-mm3 (COPS) interface from an Application Manager to PCMM Policy Server 142. In an exemplary embodiment, PacketCable security applies to the interface.

PCMM PDP 141 implements the PCMM Application Manager (AM) function. PCMM PDP 141 preferably accepts the Go (COPS) interface from PDF 114, and optionally the Gq (Diameter) interface from P-CSCF 113. PCMM PDP 141 preferably responds to the protocols on those interfaces with COPS commands to PCMM Policy Server (PS) 142, acting as a QoS Proxy for SIP UE 119. Responses from PCMM PS 142 need to be translated into appropriate actions on the IMS interfaces.

In IMS, two UEs perform an end-to-end message exchange using SIP and SDP to negotiate media characteristics such as the codec to be used. P-CSCF 113 preferably uses the SDP information to make policy decisions for quality of service on the IP access network, or to interact with an external Policy Decision Function, such as PDF 114. In IMS R5, P-CSCF 113 internally performs the policy decision function and directly sends IP QoS parameters to a GGSN using the Go (COPS) interface. In IMS R6, PDF 114 is separated from P-CSCF 113 and becomes a stand-alone unit. The R6 P-CSCF interacts with PDF 114 over the Gq (Diameter) interface and the R6 PDF interacts with the GSM/UMTS Gateway GPRS Support Node (GGSN) using the Go (COPS) interface.

For PCMM PDP 141, the Go (COPS) interface is the preferred interface to implement since it will apply in both R5 and R6. PCMM PDP 141 preferably translates commands and responses on the Go (COPS) interface that are meant for a GGSN into commands and responses on the Pkt-mm3 (COPS) interface into a standard PCMM Policy Server 142. The Gq (Diameter) interface can alternately be implemented in Cable Gateway 101 when interfacing with an integrated PDF.

Go Proxy 151 comprises software that monitors the SIP messages to and from SIP UE 119 and logically implements the Go interface into the QoS Proxy (PCMM PDP 141) for SIP UE 119. Go Proxy 151 software is preferably utilized when the IMS implementation does not support the Go or Gq interfaces.

Go Proxy 151 includes software that logically derives the IMS Go (COPS) interface from a replication of the Gm (SIP) interface that is sent from the IMS UE to P-CSCF 113. The Gm (SIP) interface is preferably replicated by P-CSCF 113 after it has be successfully received in the clear, or extracted into the clear from a Transport Layer Security (TLS) security association between the IMS UE and P-CSCF 113. TLS is a protocol that ensures privacy between communicating applications and their users on the Internet. When a server and client communicate, TLS ensures that no third party may eavesdrop or tamper with any message. TLS is the successor to the Secure Sockets Layer (SSL).

In an exemplary embodiment of the present invention, the Gm (SIP) interface is not secured between P-CSCF 113 and Cable Gateway 101. Go Proxy 151 must recognize the initiation and release of SIP sessions on the Gm interface and logically create the Go (SIP) interface into PCMM PDP 141. In an alternate exemplary embodiment, the actual implementation of Go Proxy 151 and PCMM PDP 141 use internally-defined mechanisms as long as PCMM PDP 141 is able to manage QoS for the Go (SIP) sessions.

Event Manager 171 comprises software that implements the Pkt-em3 (Radius) interface to a PacketCable Record Keeping Server. In an exemplary embodiment, PacketCable security applies to the interface. Event Manager 171 supports the production of call-related events on Cable Gateway 101 into a PacketCable 1.5 RKS interface. In an exemplary embodiment, the events can be used for billing or monitoring purposes.

E-MTA 112 is defined in CableLabs standards for PacketCable 1.0 through 1.5. P-CSCF 113 performs the functions of a standard IMS Proxy Call Session Control Function, and in addition the interface from P-CSCF 113 to Cable Gateway 101 is a replication of the Gm (SIP) interface from SIP UE 119, in the clear, without IPSec encryption. This allows Cable Gateway 101 to apply QoS for SIP UE 119 on the cable access network prior to the support of the Go or Gq interfaces on either the IMS or Cable Gateway 101.

PDF 114 performs the functions of an IMS Policy Decision Function and preferably implements the IMS Go interface. SIP UE 119 is, in an exemplary embodiment, a SIP Phone or SIP MTA.

I/S-CSCF 122 is a Standard IMS Interrogating or Service Call Session Control Function that implements the IMS Mw (SIP) interface. Cable Gateway 101 preferably harmonizes the Mw (SIP) interface to IMS I/S-CSCF 122 with the Pkt-c2 (CMSS) interface to a PacketCable 1.5 Remote CMS.

Remote CMS 123 is preferably a Standard PacketCable 1.5 Call Management System that represents at least one leg of a call that involves Cable Gateway 101. CMTS 132 is preferably defined in CableLabs standards for DOCSIS, PacketCable 1.5, and PacketCable Multimedia.

PCMM Policy Server 142 is a PacketCable Multimedia policy server that accepts the Pkt-mm3 (COPS) interface from an Application Manager and applies the Pkt-mm2 (COPS) interface to CMTS 132. PCMM Policy Server 142 acts as a Policy Enforcement Point to the Application Manager and a Policy Decision Point to CMTS 132. RKS 172 interfaces with Cable Gateway 101 using the Pkt-em3 (Radius) interface. PacketCable security applies to the Pkt-em3 (Radius) interface.

The Gm (SIP) interface is utilized between UE 119 and P-CSCF 113 and between P-CSCF 113 and Cable Gateway 101 and is the IMS reference point that uses SIP, with private header extensions, to exchange messages between IMS User Equipment (UE) and Call Session Control Function (CSCF).

The Go (COPS) interface is utilized between PDF 114 and Cable Gateway 101, and is the IMS reference point that uses COPS protocol to control QoS in the user plane and exchange charging correlation information.

The Gq (Diameter) interface is used between IMS P-CSCF 113 and Cable Gateway 101, and is the IMS reference point that uses Diameter protocol to exchange information on policy for quality of service.

The Mw (SIP) interface is used between I/S CSCF 122 and Cable Gateway 101, and is the IMS reference point used to exchange messages between CSCFs.

The Pkt-c1 (NCS) interface is utilized between E-MTA 112 and Cable Gateway 101 and is the interface for call signaling messages. The preferred protocol is Network-Based Call Signaling (NCS), a profile of MGCP.

The Pkt-c2 (CMSS) interface is used between Remote CMS 123 and Cable Gateway 101 and is the interface for call signaling. In a exemplary embodiment, the protocol is Call Management Server Signaling (CMSS), an extended version of SIP.

The Pkt-e1 (DQoS) interface is utilized between CMTS 132 and Cable Gateway 101, and is the interface, preferably COPS DQoS, that sets call data and call content surveillance for lawful intercept. The Pkt-em1 (DQoS) interface is used between CMTS 132 and Cable Gateway 101 and is the interface used to carry DQoS Gate-Set message carrying Billing Correlation ID and other data required for CMTS 132 to send Event Messages to RKS 172.

The Pkt-em2 (CMSS) interface is utilized between the CMS and the Cable Gateway 101 and is the interface used to carry Billing Correlation ID and other data required for billing. The protocol is preferably CMSS, which is an extended version of SIP.

The Pkt-em3 (Radius) interface is used between RKS 172 and Cable Gateway 101 and is the interface carrying PacketCable event messages from Cable Gateway 101 to RKS 172 and preferably uses the Radius as a transport protocol.

The Pkt-mm2 (COPS) interface is used between PCMM Policy Server 142 and CMTS 132 and is the interface used to set quality of service gates on CMTS 132. The Pkt-mm-2 (IPSec) interface is utilized between PCMM Policy Server 142 and CMTS 132 and is used as a security interface.

The Pkt-mm3 (COPS) interface is used between PCMM Policy Server 142 and Cable Gateway 101 and is the interface used to set quality of service gates on CMTS 132. The Pkt-mm-3 (IPSec) interface is utilized between PCMM Policy Server 142 and Cable Gateway 101 and is used as a security interface.

The Pkt-p6 (Kerberos) interface is used between E-MTA 112 and Cable Gateway 101 and is the interface used to establish IPSec Security Association using Kerberos protocol.

The Pkt-q3 (DQoS) interface is used between E-MTA 112 and Cable Gateway 101 and is a signaling interface. Parameters that cross this interface preferably include IP addresses, port numbers, and selection of Codec and packetization characteristics.

The Pkt-q4 interface is utilized between CMTS 132 and Cable Gateway 101 and is the interface for controlling quality of service gates for media stream sessions.

The Pkt-q6 interface is used between Remote CMS 123 and Cable Gateway 101 and is the interface used to establish intra-domain and inter-domain sessions between two PacketCable CMSs. The Pkt-q6 interface preferably includes methods to ensure QoS resources are available on both ends of a connection before a call is allowed to complete.

The Pkt-s5 (IPSec) interface is used between E-MTA 112 and Cable Gateway 101 and provides security interface, message integrity and privacy via IPSec. The Pkt-s6 (IPSec) interface is utilized between RKS 172 and Cable Gateway 101 and provides a security interface, message integrity and privacy via IPSec. The Pkt-s8 (IPSec) interface is used between CMTS 132 and Cable Gateway 101 and provides a security interface, message integrity and privacy via IPSec.

The Pkt-s16 (IPSec) interface is used between Remote CMS 123 and Cable Gateway 101 and provides a security interface, message integrity and privacy via IPSec.

The CMSS/Mw Normalization interface is utilized between software that harmonizes the standard Pkt-c2 (CMSS) interface to Remote CMS 123 and the standard IMS Mw (SIP) interface to IMS I/S-PSCF 123. PacketCable security applies to the Pkt-c2 interface. The TLS (IMS) interface is used between UE 119 and P-CSCF 113 and is the Transport Layer Security, IETF protocol used for security in the IMS architecture.

The present invention utilizes a cable gateway to provide consumer features in a VoIP application. Cable Gateway 101 works in the Media and End Point layer to normalize the PacketCable/DOCSIS cable access network into 3GPP/3GPP2 IMS. By normalizing into the 3GPP/3GPP2 IMS architecture, the cable access network can now be blended into a consistent session/application infrastructure that spans multiple access technologies, for example, UMTS, 802.11, Bluetooth, Cable, DSL, FTTP, WiMAX, etc. The advantage of this approach over a cable-specific definition for the Next Generation Network (NGN) is the freedom it offers the network operator to add different broadband access networks to their portfolio, without modifying the elements of the core NGN network. If a cable-specific definition is taken, then blending cable access with, for example, DSL or wireless broadband, will require two infrastructures.

While this invention has been described in terms of certain examples thereof, it is not intended that it be limited to the above description, but rather only to the extent set forth in the claims that follow.

We claim:

1. A Cable Gateway comprising:
an Embedded Multimedia Terminal Adaptor (E-MTA) Normalization function that comprises translation software that normalizes E-MTA interfaces to appear to an IP Multimedia Subsystem (IMS) as SIP user equipment and performs initialization, call signaling, registration, authentication and security;
a Call Management Server Signaling (CMSS)/Mw Normalization function that interworks calls going between the IMS and a RemoteCMS;
a Gate Controller function that implements signaling interfaces to a Cable Modem Termination System (CMTS) and allows the E-MTA Normalization function and the CMSS/Mw Normalization function to interact with the CMTS to define, operate, and destroy QoS gates as a part of the normalization of call-flow protocols;
a PacketCable Multimedia (PCMM) Policy Decision Point (PDP) function that implements a PacketCable Multimedia interface from a PCMM Application Manager to a PCMM Policy Server, the PCM PDP implements the PCMM Application Manager;
a Go Proxy that monitors SIP messages to and from user equipment and implements an interface into a QoS Proxy for the user equipment; and
an Event Manager that implements an interface to a PacketCable Record Keeping Server and supports the production of call-related events on the Cable Gateway.

2. A Cable Gateway in accordance with claim 1, wherein the E-MTA Normalization function comprises:
an NCS Call Agent responsible for mapping the NCS protocol of the E-MTA into an accepted protocol; and
an MTA Authorization function performing initialization, authentication, and security.

3. A Cable Gateway in accordance with claim 2, wherein the MTA Authorization function performs registration by utilizing registration methods used at a SIP interface.

4. A Cable Gateway in accordance with claim 3, wherein the MTA Authorization function coordinates the timeout of a security association of the E-MTA and a proxy SIP user equipment so that re-authorization requests from the E-MTA occur before the timeout of the registration in the IMS.

5. A Cable Gateway in accordance with claim 2, wherein the MTA Authorization function performs authentication by utilizing IMS authentication methods.

6. A Cable Gateway in accordance with claim 2, wherein the MTA Authorization function performs authentication for every registration request.

7. A Cable Gateway in accordance with claim 1, wherein the Cable Gateway stores the user identity and password for HTTP Digest authentication of a proxy user equipment that represents the E-MTA.

8. A Cable Gateway in accordance with claim 1, wherein the CMSS/Mw Normalization function comprises software that provides a SIP interface comprising extensions for carrying parameters specific to the architecture.

9. A Cable Gateway in accordance with claim 1, wherein the CMSS/Mw Normalization function comprises supporting the interaction of IMS session control and a feature server with standard CMSs.

10. A Cable Gateway in accordance with claim 1, wherein the Go Proxy is utilized when the IMS implementation does not support a predetermined interface.

11. A Cable Gateway in accordance with claim 10, wherein the predetermined interface is a Go interface.

12. A Cable Gateway in accordance with claim 10, wherein the predetermined interface is a Gq interface.

13. A Cable Gateway in accordance with claim 1, wherein the Go Proxy derives an IMS interface from a replication of a SIP interface that is sent from an IMS user equipment.

14. A Cable Gateway in accordance with claim 1, wherein the Cable Gateway only provisions subscriber information when the subscriber information is needed for translation.

15. A Cable Gateway in accordance with claim 1, wherein the Cable Gateway functions as a Gate Controller.

16. A Cable Gateway in accordance with claim 1, wherein the Cable Gateway functions as a PCMM Application Manager interacting with a PCMM Policy Server.

17. A Cable Gateway comprising:
a CMS Proxy that interacts with an Embedded Multimedia Terminal Adaptor (E-MTA) as if it was a CMS, the CMS Proxy normalizing the behavior of the E-MTA to make them appear to the IP Multimedia Subsystem (IMS) network as multiple instances of IMS User Equipment; and
a PacketCable Multimedia (PCMM) Application Manager that interacts with a PCMM Policy Server to accomplish the definition, operation, and destruction of QoS gates on a PCMM Cable Modem Termination System (CMTS) as a part of the normalization of call-flow protocols.

18. A Cable Gateway in accordance with claim 17, wherein the CMS Proxy comprises:
an E-MTA Normalization function that interacts directly with E-MTA interfaces and normalizes the behavior to the IMS Gm (SIP) interface;
a Call Management Server Signaling (CMSS)/Mw Normalization function that interworks the IMS I/S-CSCF (Call State Control Function), via the Mw (SIP) interface, to a remote CMS, via a plurality of interfaces that use the CMSS protocol;
a Gate Controller function that communicates with a Cable Modem Termination System (CMTS) to manage QoS gates; and
an Event Manager function that communicates with a Record Keeping Server (RKS) with call events.

19. A Cable Gateway in accordance with claim 17, wherein the PCMM Application Manager comprises:
a PacketCable Multimedia (PCMM) Policy Decision Point (PDP) function that implements a PacketCable Multimedia interface from a PCMM Application Manager to a PCMM Policy Server, the PCM PDP initializes the PCMM Application Manager; and
a Go Proxy that monitors SIP messages to and from user equipment and implements an interface into a QoS Proxy for the user equipment.

20. A Cable Gateway in accordance with claim 17, wherein the Cable Gateway is a standalone computing server that gives the appearance of a PacketCable CMS to elements of a PacketCable network and the appearance of IMS functional elements to an IMS network.
